(19) United States
(12) Patent Application Publication
(10) Pub. No.: US 2005/0145138 A1
(43) Pub. Date: Jul. 7, 2005

(54) Oxygen barrier material for packaging

(75) Inventors: Kothapalli Venkata Surya Narayana Raju, Hyderabad (IN); Kattimuttathu Ittara Suresh, Hyderabad (IN); Bhamidipalli Subrahmanya Sitaramam, Hyderabad (IN); Sundergopal Sridhar, Hyderabad (IN); Asad Ali Khan, Hyderabad (IN)

Correspondence Address: WOMBLE CARLYLE SANDRIDGE & RICE, PLLC, P.O. BOX 7037, ATLANTA, GA, 30357-0037, US

(73) Assignee: Council of Scientific and Industrial Research, New Delhi (IN)

(21) Appl. No.: 10/747,616

(22) Filed: Dec. 30, 2003

(51) Int. Cl. B32B 5/16

(52) U.S. Cl. 106/416; 428/328; 428/325; 106/437

(57) ABSTRACT

A coating composition for packaging material, and a process for developing packaging material having very low oxygen and water vapour permeability useful for packaging of food materials, particularly oil packaging. The process involves developing a coating composition with calcined clay as the functional additive and coating paper boards to a thickness of 50-100 microns with the coating composition from which suitable packing containers could be fabricated.

### FIELD OF THE INVENTION

The present invention relates to an inexpensive, alternative oxygen barrier material for the packaging industry. The present invention is useful for the packaging industry in general particularly for packaging of edible oils.

### BACKGROUND OF THE INVENTION

Plastics and other materials have found increasing use as replacements for glass and metal containers in packaging. Advantages of such packaging over glass packaging include light weight, decreased breakage and potentially lower costs. Shortcomings in the gas barrier properties of common packaging materials present major problems to those in the packaging industry, when such materials are used to pack oxygen sensitive items and/or carbonated beverages. Specially, gases such as oxygen and carbon dioxide can readily permeate through most of the packaging materials (not glass and metal) commonly used by the packaging industry. The Oxygen Permeability Constant (OPC) of such packaging materials quantifies the amount of oxygen, which can pass through a film or coating under a specific set of circumstances.

Several methods are known to enhance the barrier property to oxygen and moisture of the packaging material by applying thick or multiple layers of polymeric coating.

Reference may be made to U.S. Pat No. 3,959,526 wherein a process of preparing a high barrier, heat sealable packaging material with a low level of total retained solvents is described. A inner coating of a high barrier vinylidene chloride copolymer and a top coating of a heat sealable vinylidene chloride copolymer are applied as solution to deposit a film. Such barrier polymer coatings are costly. Another U.S. Pat. No. 4,781,978 discloses articles with a coating used for promoting adhesion. The coating is formed from a blend of carbonylamide functional groups and hydrophobic polymer. U.S. Pat. No. 3,950,579 discloses a method of forming relatively thick deposits of polymeric material on a surface of small treaded articles, which form a thin coating on the surface from a solution of the polymeric material. The polymeric material is polyurethane or preferably an acrylic or methacrylic resin in combination with an adhesion promoting material such as a polyamide or a silicone resin. U.S. Pat. No. 4,565,742 discloses a film laminate prepared by a variety of lamination and coating processes. The film comprises a base film of polyester or nylon, a coating of polyvinylidene chloride and a sealant layer of ethylene vinyl acetate copolymer. Japanese patent application 59-152929 discloses a method for treating a thermoplastic polyester container by coating the container with a polymer dispersion or solution. In one example a first coating of saponified polyvinyl acetate is applied, then Vinylidene chloride polymer latex, followed by drying. Another U.S. Pat. No. 5,061,534 discloses a first layer comprising an ethylene vinyl alcohol copolymer and a second layer comprising a vinylidene chloride copolymer. Packages made with the vinylidene chloride copolymer layer between the low ethylene content ethylene vinyl alcohol copolymer and the contained product provide high oxygen barrier properties under both high and low humidity conditions. U.S. Pat. No. 5,728,439 discloses a multilayer packaging material for oxygen sensitive food and beverages. Another U.S. Pat. No. 6,054,212 discloses that biaxially oriented polyester film coated with another polymer, which is having Tg less than that of polyester, has low atmospheric oxygen transmission. It is particularly suitable for packaging applications, especially for packaging foodstuffs and other consumable items.

U.S. Pat. No. 5,328,724 discloses a process for applying a barrier layer of ethylene vinyl alcohol copolymer to a substrate such as a plastic film, by coating the substrate with a solution of ethylene vinyl alcohol in a solvent of tetrahydrofuran and water followed by removing the solvent. Multi-layer structures having an ethylene vinyl alcohol barrier layer coated on a plastic substrate in aqueous tetrahydrofuran solvent have excellent oxygen barrier properties.

Prior art processes [U.S. Pat. No. 5,543,223, U.S. Pat. No. 5,830,545, U.S. Pat. No. 4,753,832] to achieve barrier properties in packaging materials are based on the multi-layer polymer films, where the barrier property is given by materials like, ethylene-vinyl alcohol copolymer (EVOH), saran-Polyvinylidene fluoride (PVDF), Metallised PP etc. These materials are expensive compared to the general purpose plastics like PE or PP and also involve energy intensive melt mixing and extrusion techniques to make the multi-layer material. Research and developments efforts are being reported to make barrier materials based on amorphous polymers. As opposed to the prior art, the present invention uses coating compositions, without using any expensive processing operations or additives to make barrier coating materials.

The materials currently in use to achieve the oxygen or water vapor barrier properties are based on costly raw materials such as PVDF or EVOH copolymers. Normally multilayer materials are designed with these copolymers requiring energy intensive processes for fabrication, sometimes with lowered performance. The use of calcined clay in coating formulations to improve the barrier properties is not known in the prior art.

### SUMMARY OF THE INVENTION

One object of the present invention is to provide inexpensive, alternative oxygen barrier material for packaging industry.

Another object of the present invention is to develop coating compositions with calcined clay (hereinafter referred to as clay) with other fillers and additives to give films with improved barrier to oxygen and water vapour. Still another object of the present invention is to incorporate calcined clay to the coating formulation without sacrificing the optimum mechanical properties.

Still another object of the present invention is to study the effect of formulating variables on the barrier properties of the developed packaging material.

The present invention relates to an inexpensive, alternative oxygen barrier material for the packaging industry. The present invention is useful for the packaging industry in general particularly for packaging of edible oils.

### DESCRIPTION OF THE INVENTION

The present invention provides a coating formulation, which gives very good barrier properties to oxygen and water vapour when the coating is used in a multilayer packaging material. In accordance with this invention, a multilayer packing material includes of a first layer of cardboard, a second layer of the said developed coating and a third layer of olefin based film.

The second layer of coating film is formed from a film forming binder, pigments, additives etc. The film forming binder is selected from a group of alkyds, epoxies, polyurethanes, and urethane alkyds that are available commercially.

Examples of alkyds are long oil alkyds, medium oil alkyds or urethane alkyds prepared from oils like linseed, safflower, and dehydrated castor oil. Epoxy resins are the reaction products of aromatic diol like bisphenol with epichlorohydrin. Polyurethanes are the reaction products of hydroxylated polyesters (may be derived from oils or other polyols) with isocyanate (may be aliphatic or aromatic). Hydroxy polyesters are the reaction products of aliphatic or aromatic diol with dicarboxylic acids.

Coating film may also include pigments like titanium dioxide, iron oxide, zinc oxide etc., and fillers like talc, barytes, clay material and additives like dispersants, antisettling agents, flow control agents etc., and solvents like white spirit, toluene, cellosolve acetate, MIBK, MEK etc.

Using the film formers, pigments, additives and solvents, coatings are formulated and the dry films of this coatings have very good oxygen barrier properties.

Accordingly the present invention provides inexpensive, alternative oxygen barrier material for packaging industry which comprise developing a coating composition with calcined clay and coating paper boards on one side with the said developed coating to a thickness of 50-100 microns and fabricating suitable container with the said multilayer packaging material.

An object of the present invention is achieved by means of preparing packaging material having a base layer of card board and having at least one cover layer, wherein the cover layer is composed of a film former, pigments and additives. The novel film coated packaging materials generally has oxygen permeability very, much less, which is beyond the limits of measurable range.

In this packing material with the coating film, the binder of the coating layer comprise of at least 50-75% by volume of film former and up to 25-50% by volume of other pigments and fillers.

The coating layer may contain pigments, fillers and additives. They are expediently added to the film former or their mixture before grinding them in the ball mill. Examples of such pigments are titanium dioxide, iron oxide, zinc oxide, talc, calcium carbonate, amorphous silica, magnesium carbonate, barium carbonate, carbon black, kaolin, china clay, and barytes.

The additives selected may also be mixtures of two or more different agents. Pigment concentrations of 1 to 20% by volume are particularly suitable.

Later the composition may be cured; that is, it may be treated to remove volatile components of the composition to form a non-tacky and transparent layer, which adheres to the substrate. The coating film may be applied by conventional coating techniques like brush, spray, roller, air less spray etc., depending on the coating formulation, which is selected.

The thickness of the coating film may vary within wide limits and depends on several factors including the application method used. It is preferably from 50 to 200 μm, in particular from 75 to 150 μm, preferably from 85 to 125 μm. The cardboard after application of this coating film should be free from film defects, pin holes, fish eyes etc.

The third layer usually of polyethylene preferably of LDPE, is approximately about 100-200 μm thick.

The composite packaging material has excellent suitability for packaging oils, food stuffs and consumable items, which are sensitive to oxygen.

In this invention we achieved major improvement in barrier property was achieved by using clay as an additive in coating formulations. The disclosed invention thus provides substantial improvement in the water vapor and oxygen barrier permeability of the films obtained using clay as an additive. General formulations, illustrating the composition used (in Weight Percentage) is given below.

In a typical formulation 100-200 g typically 165 g of resin from a group consisting of alkyd, epoxy, or polyurethane, uralkyd and 100-200 g typically 166.2 g of TiO₂, 20-50 g, typically 28.5 g of Talc and Calcined clay, 0-30 g, as required in the formulation were added and required quantity of a solvent mixture comprising xylene and toluene or MIBK were added such that the total volume of all the ingredients did not exceed 250 ml. The said mixture comprises nearly ⅔ of, typically, a 500 ml bottle, which was already filled with ceramic pebble used to facilitate grinding, it is then kept for grinding on a ball mill for 2 days. The coating composition was formulated for 25% PVC (Pigment Volume Concentration). The following are some illustrative compositions used.

Composition I

| | |
|---|---|
| Epoxy resin | 24-48% |
| TiO₂ | 24-48% |
| Talc | 9-22% |
| Clay | 0-30% |
| Colorant | 0-1% |
| Barytes | 0-5% |
| Nilset117 | 0.1-0.2% |
| HapcoNXZ | 0.05-0.1% |
| Dispersitol | 0-0.1% |
| Borchi GOL E2 | 0.5-0.8% |
| Solvent | q.s (for application) |

Composition II

| | |
|---|---|
| Alkyd resin | 24-48% |
| TiO₂ | 24-48% |
| Talc | 9-22% |
| Clay | 0-30% |
| Catalyst | 0.1-0.5% |
| Colorant | 0-1% |
| Barytes | 0-5% |
| Nilset 117 | 0.1-0.2% |
| Hapco NXZ | 0.05-0.1% |
| Dispersitol | 0-0.1% |
| Borchi GOL E2 | 0.5-0.8% |
| Solvent | q.s (.for application) |

Composition III

| | |
|---|---|
| Polyester polyol + isocyante | 24-48% |
| TiO₂ | 28-40% |
| Talc | 9-22% |
| Clay | 0-30% |
| Colorant | 0-1% |
| Barytes | 0-5% |
| Nilset 117 | 0.1-0.2% |
| Hapco NXZ | 0.05-0.1% |
| Dispersitol | 0-0.1% |
| Borchi GOL E2 | 0.5-0.8% |
| Solvent | q.s.(for application) |

Composition IV

| | |
|---|---|
| Castor polyol + isocyanate | 24-48% |
| TiO₂ | 18-40% |
| Talc | 9-22% |
| Clay | 0-30% |
| Colorant | 0-1% |
| Barytes | 0-5% |
| Nilset 117 | 0.1-0.2% |
| Hapco NXZ | 0.05-0.1% |
| Dispersitol | 0-0.1% |
| Borchi GOL E2 | 0.5-0.8% |
| Solvent | q.s.(for application) |

Composition V

| | |
|---|---|
| Uralkyd resin | 28-40% |
| TiO₂ | 31-52% |
| Talc | 9-22% |
| Clay | 0-30% |
| Catalyst | 0.1-0.5% |
| Colorant | 0-1% |
| Barytes | 0-5% |
| Nilset 117 | 0.1-0.2% |
| Hapco NXZ | 0.05-0.1% |
| Dispersitol | 0-0.1% |
| Borchi GOL E2 | 0.5-0.8% |
| Solvent | q.s. (for application) |

The invention also provides a method for preparing a multiple layered packaging material, comprising the steps of:
(a) providing a first layer consisting of cardboard,
(b) coating the first layer with a second layer of coating material as claimed in claim 1 and drying it to obtain a coated first layer, the coating being of 50 to 200 μm thickness, and
(c) laminating the coated first layer with a third layer of an olefin selected from polyethylene and polypropylene, the third layer being about 40 μm in thickness.

The invention is illustrated by the following examples which should not be construed as to limit the scope of the invention in any manner.

### EXAMPLE 1

A typical formulation used for the coating comprises and is given by way of illustration, the binder resin selected from a group of alkyd, epoxy, urethane alkyd, polyurethane, or a combination of these such that the total weight % of the binder does not exceed the filler. Coating formulations were prepared by mixing together all the ingredients in a suitable container made of metal or glass and is filled ⅔ of its volume with the said mixture of additives and the solvent or solvent mixture and is kept for grinding on a ball mill for a period of not less than 8 hours and to maximum period of 24 hours or for a period of time required to get a good dispersion.

In a typical formulation 100-200 g typically 165 g of alkyd resin or 10-90 g typically 82.5 g of epoxy resin or 10-50 g, typically, 40 g of -polyester polyol in combination with stoichiometric quantity of isocyanate or 90 to 150 g of polyurethane, typically, 142.5 g of one pack polyurethane or 25 to 75 g, typically, 35 g of castor polyol with proportionate amount of isocyanate were weighed to the container, then 100-200 g ,typically 165 g of TiO₂, 20-50 g, typically 28.5 g of Talc and Calcined clay, 0-100 g, as required in the formulation were added and required quantity of a solvent mixture comprising xylene and toluene or MIBK were added such that the total volume of all the ingredients did not exceed 200 ml. The said mixture comprises nearly ⅔ of, typically, a 500 ml bottle which was already filled with ceramic pebble used to facilitate grinding. it is then kept for grinding on a ball mill for 2 days. The coating composition were formulated for PVC (Pigment Volume Concentration) values of 10, 20 and 25. The following example is descriptive of the formulation used:

### EXAMPLE 2

| | |
|---|---|
| Epoxy resin | 34% |
| TiO₂ | 34% |
| Talc | 6% |
| Calcined clay | 4.8-28% |
| Colorant | 0.1% |
| Barytes | 5% |
| Nilset 117 | 0.1-0.2% |
| Hapco NXZ | 0.05-0.1% |
| Dispersitol | 0.1% |
| Borchi GOL E 2 | 0.5-0.8% |
| Solvent | 25% |

To the said composition is added stoichiometric amount of hardener, mixed thoroughly with a glass road or suitable mixing device and is then coated as a free film of 50-100 micron thickness.

The coating composition so developed have the following characteristics: Fineness of grind-Hegmann gauge No.7 Viscosity Ford cup No. 4, 40-60 depending upon the application method.

The so developed coating is also applied to paper boards coated on one side with polyethylene film, which is available commercially (supplied by ITC paper boards, Bangalore, India), to a thickness of 50-100 microns and dried for a period of minimum 24 hours or necessary period to make it tack free. The packaging material so developed consists of paper board coated on one side with the barrier coating and the other side laminated with polyethylene film of thickness about 100 micron.

The coated paperboards, the said developed packaging material, the object of the present invention is tested for characterising the barrier properties. The oxygen barrier properties were measured by using continuous flow method, which is in accordance with ASTM D-3985-81. A brief description of the method is given below:

Oxygen Permeability Measurements:

The continuous flow method was chosen to carry out the permeability measurements. The details of the method is earlier reported [J. of Memb. Sci. 159(1999) 209-219]. In this method, the penetrant permeates through the membrane into a flowing stream of inert carrier gas in the permeate compartment. The stream exiting the permeate side is analyzed by gas chromatograph to determine the permeate concentration which is multiplied by the stream flow rate and divided by barrier area to give the permeation flux. The permeability coefficient is determined by dividing the product of flux and effective barrier thickness with partial pressure difference of O₂ gas across the barrier. This continuous flow method was preferred since the measurement of low as well as high permeation rates could easily be achieved by varying the carrier gas flow rate so as to bring the concentration of the penetrant in the permeate stream within the detectable range of the analyser i.e., gas chromatograph.

A pressure differential of about 1-5 kgs/cm2 (100-500 kPa) was maintained across the membrane during experiments. All experiments were conducted at room temperature (30 ±2° C.). The feed and permeate lines were initially evacuated by means of a vacuum pump. Pure oxygen was introduced slowly into the feed line by means of a mass flow controller. The desired feed pressure difference was maintained in the test cell. The permeate gas, sample was collected in SS 316 gas sampler using iolar grade nitrogen (>99.9% purity) as the carrier gas (the flow rate of the carrier gas was controlled by a soap bubble meter). Only steady state samples were collected. The feed and permeate samples were analyzed with Nucon Gas Chromatograph Model 765,India, equipped with a CTR dual column and a Thermal conductivity Detector (FID). The concentration of the permeated oxygen was determined and gas permeability's were calculated.

Water vapour transmission rate is measured by using Payne Cup method in accordance with ASTM E-96-66. The brief description of the method is given below: At least three test specimens, coated films here, shall be tested for each sample. Filled the Payne cup with desiccant to within 6 mm of the specimen and place the test specimen over the cup and seal the cup as per the procedure given in the ASTM standard. Place these cups in the dessicator, which is maintained, at 90% humidity with the help of aqueous solutions (ASTM E-104-51). These dessicator were placed in the incubator at 37.8° C. (100° F.). The exposed area of the films is 1.017×10⁻³³ m². Make successive weighing of the assembly at suitable intervals until a constant rate of gain is attained. The water vapour transmission rate is calculated and reported as g/m².24 h.

The free films, accordingly, prepared from example 6, had a water vapour permeability of 3.44 to 1.97 g/m².24 hour and oxygen permeability in the range of 426.5 to 1.9 cc.mil/100 in^{2.}day.atm as the clay content is increased from 0-28% or 0-30 ml. The said composition had an adhesive strength in the range of 250-104 kg/cm². The tensile strength of the free films for 0% clay content is 0.516 kgf/mm^{2.}from 10 and 20 ml clay loading the tensile strength was 1.75 and 2.25 kgf/mm². A second example of the coating composition is which was prepared according to formulation given in example 6.

### EXAMPLE 3

| | |
|---|---|
| Alkyd | 38.5% |
| TiO₂ | 38% |
| Talc | 6.6% |
| Clay | 4.7% |
| Catalyst | 0.5% |
| Colorant | 0.1% |
| Barytes | 5% |
| Nilset 117 | 0.1-0.2% |
| Hapco NXZ | 0.05-0.1% |
| Dispersitol | 0.1% |
| Borchi Gol E 2 | 0.5-0.8% |
| Solvent | 14% |

The films were made as described in detail in the first example and had the following properties Tensile strength in the range of 0.88-0.96 kgf/mm^{2.} The oxygen permeability of the films varied from 11.8-2.3 cc mil/100 in².day.atm.

The supported films had a Water Vapour Transmission rate (WVTR) expressed as mg/cm².mm thickness.24 hour. 4.55 for the minimum clay loading and 2.27 for the maximum clay loading. the adhesive strength of the composition was 212 kg/cm² for the maximum clay loading and 247 kg/cm² for the minimum clay leading.

### EXAMPLE 4

| | |
|---|---|
| Polyester polyol | 27.8% |
| Isocyanate | 25% |
| TiO₂ | 33% |
| Talc | 5.6% |
| Calcined Clay | 4.7 to 28% |
| Colorant | 0.1% |
| Barytes | 5% |
| Nilset 117 | 0.1-0.2% |
| Hapco NXZ | 0.05-0.1% |
| Dispersitol | 0.1% |
| Borchi Gol E 2 | 0.5-0.8% |
| Solvent | 19.8% |

Subjected to 48 hours of grinding.

The free films had a water vapour permeability of 9.34 to 8.19 g/m².24 hour and oxygen permeability in the range of 11 to 3.1 cc.mil/100in^{2.}day.atm as the clay content is increased from 0-28% or 0-30 ml. The said composition had an adhesive strength in the range of 323-377 kg/cm². The tensile strength of the free films for 0% clay content is 1.20 kgf/mm^{2.} for 10 and 20 ml clay loading the tensile strength was 1.20 and 1.36 kgf/mm².

### EXAMPLE 5

Further example of the formulation used is made according to the formulation:

| | |
|---|---|
| Castor polyol | 26% |
| Isocyanate | 22% |
| TiO₂ | 34% |
| Talc | 5.8% |
| Clay | 5-30% |
| Colorant | 0.1% |
| Barytes | 5% |
| Nilset 117 | 0.1-0.2% |
| Hapco NXZ | 0.05-0.1% |
| Dispersitol | 0.1% |
| Borchi Gol E 2 | 0.5-0.8% |
| Solvent- | 20% |

The free films had a water vapour permeability of 11.45 to 9.62 g/m².24 hour and oxygen permeability in the range of 17 to 4.7 cc.mil/100in^{2.}day.atm as the clay content is increased from 0-28% or 0-30 ml. The said composition had an adhesive strength in the range of 247-424 kg/cm². The tensile strength of the free films for 0% clay content is 0.85 kgf/mm^{2.} from 10 and 20 ml clay loading the tensile strength was 1.14 and 1.51 kgf/mm².

### EXAMPLE 6

The following example further illustrates the formulation used for the coating composition.

| | |
|---|---|
| Uralkyd | 48% |
| TiO₂ | 28% |
| Talc | 4.8% |
| Clay | 4.8-28% |
| Colorant | 0.1% |
| Barytes | 5% |
| Nilset 117 | 0.1-0.2% |
| Hapco NXZ | 0.05-0.1% |
| Dispersitol | 0.1% |
| Borchi Gol E 2 | 0.5-0.8% |
| Toluene | 7% |

The free films had a water vapour permeability of 16.12 to 20.10 g/m².24 hour and oxygen permeability in the range of 436.3 to 21 cc.mil/100 in^{2.}day.atm as the clay content is increased from 0-28% or 0-30 ml. The said composition had an adhesive strength in the range of 247-318 kg/cm². The tensile strength of the free films for 0 % clay content is 1.26 kgf/mm^{2.}from 10 and 20 ml clay loading the tensile strength was 1.37 and 1.30 kgf/mm². A container fabricated with the said packaging material coated with the composition disclosed in example 3 above was used for refined Sunflower oil packaging The sample was subjected to accelerated testing at 800° C. along with another sample in a beaker. The deterioration of the oil is checked by determination of the peroxide content. The peroxide content of the sample in the beaker increased by 112% in 24 hours, where as the oil packed in the said packaging material increased only by 16%, showing better storage stability of the oil in the said developed article of this invention.

A comparative data is provided below with the commercially available materials:

| | | W, V, T, R |
|---|---|---|
| | O₂ | (g/m² · 24 hr. |
| Sample | (_{cc.mil/100}in², dat, atn) | 38° C. 90% RH) |
| Matallised PP | 5.07 | 3.9-4.8 |
| Saran 3E | 1 | 2.8 |
| LDPE | 250-800 | 15.5-18 |
| HDPE | 30-250 | 4.7-10.8 |
| EVOH | 1.15 | 22-59 |
| PET | 4.8-9 | 21 |
| IICT-unmodified coating | 11-18 | 3.44-26 |
| Clay-modified film | 1.9-3.1 | 1.97-3.44 |
| LDPE/paper/IICT coating | Below detectable range | 2.46-3.26 |

Ref: A. S. Athalye, Popular Plastics & Packaging, February 1999, 57-66

The main advantages of the present invention are: The use of costly speciality polymers like PVDF or EVOH copolymers to achieve the barrier property is eliminated by the use of calcined clay modified polymer coating. One of the methods of improving the plastic packaging material's OPC value is to treat them chemically and/or physically e.g. Metalised plastics. This method is typically expensive. The process used for making a barrier coating is less energy intensive compared to the currently used processes like extrusion. For example, The WVTR (Water Vapour Transmission Rate) of a PVC film is 30-40 g/m2.24.hour at 38 ° C. and 90% RH (Relative Humidity) for a 25 micron film. The WVTR with the coating compositions disclosed in the present invention is 2.46-3.26 g/m2.24 hour.25 micron film. Thus it has superior barrier to water vapour in comparison to the commercial PVC films used for packaging and yet its production is cheaper compared to the production process for PVC films.

1. A coating material comprising:

| | |
|---|---|
| Alkyd/Epoxy resin | 24-48% |
| TiO₂ | 24-48% |
| Talc | 9-22% |
| Calcined Clay | >0-30% |
| Catalyst | 0-1% |
| Colorant | 0-1% |
| Barytes | 0-5% |
| Nilset117 | 0.1-0.2% |
| HapcoNXZ | 0.05-0.1% |
| Dispersitol | 0-0.1% |
| Borchi GOL E2 | 0.5-0.8% |
| Solvent | q.s., |
| and reaction products thereof. | |

2. The coating material according to claim 1, wherein the amount of calcined clay is at least 4%.

3. A packaging material comprising:
a first layer of cardboard;
a second layer of a coating material; and
a third layer of olefin;
wherein the coating material comprises:

| | |
|---|---|
| Alkyd/Epoxy resin | 24-48% |
| TiO₂ | 24-48% |
| Talc | 9-22% |
| Calcined Clay | >0-30% |
| Catalyst | 0-1% |
| Colorant | 0-1% |
| Barytes | 0-5% |
| Nilset117 | 0.1-0.2% |
| HapcoNXZ | 0.05-0.1% |
| Dispersitol | 0-0.1% |
| Borchi GOL E2 | 0.5-0.8% |
| Solvent | q.s., |

and reaction products thereof.

4. The packaging material of claim 3, wherein the coating material is based on alkyd.

5. The packaging material of claim 3, wherein the coating material is based on urethane alkyd.

6. The packaging material of claim 3, wherein the coating material is based on epoxy.

7. The packaging material of claim 3, wherein the coating material is based on urethanes.

8. The packaging material of claim 3, wherein the olefin is selected from the group consisting of polyethylene and polypropylene.

9. The packaging material of claim 3, wherein the second layer has a thickness of 50 to 200 μm.

10. The packaging material of claim 3, wherein the second layer has a thickness of 75 to 150 μm.

11. The packaging material of claim 3, wherein the second layer has a thickness of 85 to 125 μm.

12. The packaging material of claim 3, wherein the third layer has a thickness of 100 to 200 μm.

13. The packaging material of claim 3, wherein the first layer supports the second and third layers.

14. A package comprising the packaging material of claim 3.

15. A method for preparing a multiple layered packaging material, comprising the steps of:
(a) providing a first layer of cardboard,
(b) coating the first layer with a second layer of coating material and drying the coating material to obtain a coated first layer, the coating material being 50 to 200 μm thick, and
(c) laminating the coated first layer with a third layer of an olefin, wherein the coating material comprises:

| | |
|---|---|
| Alkyd/Epoxy resin | 24-48% |
| TiO₂ | 24-48% |
| Talc | 9-22% |
| Calcined Clay | >0-30% |
| Catalyst | 0-1% |
| Colorant | 0-1% |
| Barytes | 0-5% |
| Nilset117 | 0.1-0.2% |
| HapcoNXZ | 0.05-0.1% |
| Dispersitol | 0-0.1% |
| Borchi GOL E2 | 0.5-0.8% |
| Solvent | q.s., |

and reaction products thereof.

16. The method of claim 15, wherein the second layer has a thickness of 75 to 150

17. The method of claim 15, wherein the second layer has a thickness of 85 to 125 μm.

18. The method of claim 15, wherein the olefin is selected from the group consisting of polyethylene and polypropylene.

19. The method of claim 15, wherein the third layer has a thickness of about 40 μm.

20. The method of claim 19, wherein:
the coating material is selected from the group consisting of alkyd, urethane alkyd, epoxy and urethane; and
the olefin is polyethylene.
